(19) United States
(12) Patent Application Publication
(10) Pub. No.: US 2007/0240151 A1
(43) Pub. Date: Oct. 11, 2007

(54) Enhanced computer target groups

(75) Inventors: Craig C. Marl, Seattle, WA (US); David C. Hennessey, Duvall, WA (US); Derek P. Menzies, Sammamish, WA (US); Edward F. Reus, Woodinville, WA (US); Jianbo Hou, Issaquah, WA (US); Marc Shepard, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/344,424

(22) Filed: Jan. 29, 2006

(51) Int. Cl. G06F 9/445

(52) U.S. Cl. 717/174

(57) ABSTRACT

Performing software installation activities. A method may be practiced for example in a network computing environment including one or more targetable entities organized into target groups. The method includes beginning a rollout including installation activities to a first set of one or more target groups. At least a portion of the installation activities are evaluated in the first set of one or more target groups. A rollout, including installation activities, to a second set of one or more target groups is begun if the installation activities in the first set of one or more target groups meet predetermined criteria.

### BACKGROUND

### BACKGROUND AND RELEVANT ART

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Organizations often have a number of computers for use by employees or members of the organization. Due to various licensing requirements, organizations often have need to maintain an inventory of software installed on computer systems throughout the organization. Additionally, there is often a need to deploy software to multiple computer system in an organization. Such software may include new applications for use by members of the organization, software updates to existing applications, and the like. Organizations may have a need to perform various software installation activities such as installing software, uninstalling software, inventorying software, and the like.

The task of installing software at computer systems within an organization is often delegated to a centralized department of the organization such as the IT department. There may be a need or desire to install software fairly quickly. For example, security updates should be installed quickly to prevent software flaws from being exploited by malicious individuals desiring to disrupt computing operations or to steal data. If an individual or group of individuals is tasked with visiting each machine in an organization, the labor costs and time costs may be unfavorable. As such, various solutions have been implemented that allow for software to be centrally distributed on a network. This allows for multiple deployments to occur simultaneously. Additionally, the deployments can be automated so as to minimize labor costs.

Common existing centralized deployment systems have used target groups to designate entities for roll-out of installation activities. In these centralized deployment systems, each entity belongs to a single target group. As such, when roll-out of installation activities occurs, either individual entities are targeted, or the target group to which the entity belongs is targeted.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One exemplary embodiment described herein includes a method of performing software installation activities. The method may be practiced for example in a network computing environment including one or more targetable entities organized into target groups. The method includes beginning a rollout including installation activities to a first set of one or more target groups. At least a portion of the installation activities are evaluated in the first set of one or more target groups. A rollout, including installation activities, to a second set of one or more target groups is begun if the installation activities in the first set of one or more target groups meet predetermined criteria.

Another exemplary embodiment described herein illustrates an alternate a method of performing software installation activities. The method may be practiced for example in a network computing environment including one or more targetable entities organized into target groups. The method includes beginning a rollout including installation activities to a first set of one or more target groups. At least a portion of the installation activities are evaluated in the first set of one or more target groups. The installation activities are halted if the installation activities in the first set of one or more target groups meet or do not meet a predetermined criteria.

Yet another exemplary embodiment illustrates a method of targeting entities. The method may be practiced for example in a computer system. The computer system defines a number of target groups. The target groups include one or more targetable entities. The method includes organizing targetable entities into target groups on the computer system where one or more targetable entities belong to a plurality of target groups. The target groups are organized in a hierarchy, where at least one targetable entity belongs to different branches in the hierarchy. A rollout is begun including installation activities to one or more of the target groups.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a heierarchial chart showing target group organization;

FIG. 2 illustrates a topology including an installation server and target groups;

FIG. 3 illustrates a method of targeting targetable entities;

FIG. 4 illustrates a alternate method of targeting targetable entities; and

FIG. 5 illustrates yet another alternate method of targeting targetable

### DETAILED DESCRIPTION

Embodiments herein may comprise a special purpose or general-purpose computer including various computer hardware, as discussed in greater detail below.

One embodiment disclosed herein facilitates installation activity roll-out, such software or data installation activities, by allowing targetable entities to belong to multiple target groups. As such, targetable entities, such as for example a target computer system, may have software or data deployed to it by rolling-out installation activities to any of the target groups to which the targetable entity belongs. This allows organizations to create specialized target groups to facilitate the flexibility in selecting targetable entities for rolling-out installation activities. For example, a targetable entity may belong to multiple groups including a server group, a database server group, and a test group. Notably, rolling-out installation activities may include rolling out packages. Such packages may include, in one example, one or more compressed cabinet files.

In one exemplary embodiment, by targeting an installation activity roll-out to the test group, software or data to be tested by the targetable entity may be deployed to the targetable entity without deploying the software or data to all other servers or database servers. Nonetheless, the targetable entity may still have software or data deployed to it as a server or database server when installation activities are rolled-out to the server and database server target groups.

To facilitate a targetable entity belonging to multiple target groups, conflict rules may be implemented. The conflict rules may be useful as conflicting installation activities may be rolled out to different target groups to which a single targetable entity belongs. For example, an installation activity that specifies that a particular application is to be installed to all test computers may conflict with an installation activity that specifies that the same application is to be uninstalled from all servers. A targetable entity may belong to both the test target group and the server target group. To resolve these conflicting roll-outs, conflict resolution rules may be implemented. For example, rules may specify weighting depending on a position in a hierarchy. Other rules may specify a preference for certain activities. For example, installations may be preferred over un-installations. Other rules may also be implemented.

Additionally, a targetable entity may be the target of a redundant roll-out as a result of belonging to more than one target group. For example, if a roll-out is directed to a test target group and a servers target group to which groups the targetable entity belongs, the roll-out will be redundant. As such, some embodiments may include functionality for verifying whether or not a package has been previously installed, and not installing a package in a roll-out if the package has been previously installed. For example, a targetable entity my receive metadata describing the applicability of the package. The targetable entity can determine that the package has previously been installed, and thus forgo installation of the package.

In an alternative embodiment, deployment servers may be able to detect redundant layouts, and ensure that metadata and/or the corresponding package are only sent a single time to a given targetable entity.

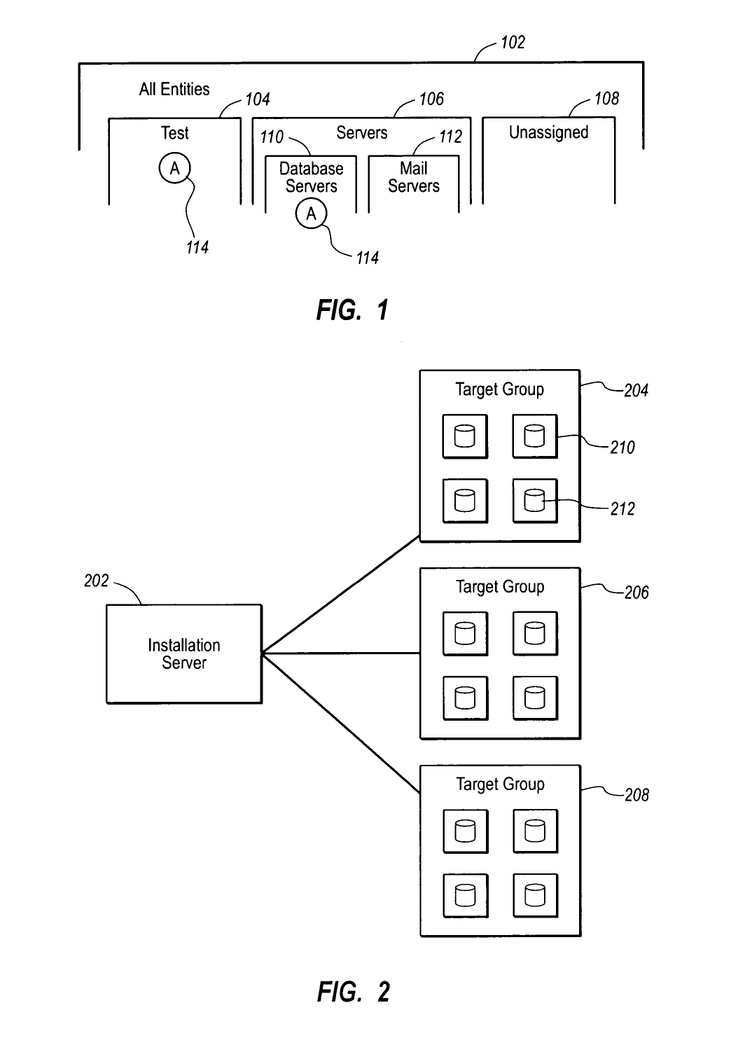

Referring now to FIG. 1, an illustrative example is shown. FIG. 1 illustrates a hierarchical arrangement of target groups where the target groups include some set of targetable entities. For example, FIG. 1 illustrates an all entities group 102. The all entities group includes all targetable entities in an organization.

Within the all entities group 102 are a number of sub-groups. For example, FIG. 1 illustrates a test target group 104, a servers target group 106, and an unassigned target group 108. As discussed previously, the target groups can be arranged hierarchically. As such, within the servers target group 106 are two lower level target groups, namely a database servers target group 110 and a mail servers target group 112.

A targetable entity, such as targetable entity A 114 may belong to multiple target groups. For example, in the example shown in FIG. 1, targetable entity A belongs to the test target group 104, the database servers target group 110, and because of the hierarchical nature of the target groups, the servers target group 106. Notably, targetable entity A 114 also belongs to two different branches in the hierarchy. Namely, targetable entity A 114 belongs to the branch that includes the test target group 104 and the branch that includes the servers target group 106.

To direct installation activities to the targetable entity A 114, installation activities may be directed to any of the target groups to which targetable entity A 114 belongs including the test target group 104, and the database servers target group 114. When installation activities are directed to a target group, the installation activities will, in one embodiment, be directed by default to target groups lower in the hierarchy. For example, installation activities directed to the servers target group 106 will also, by default, be directed to the database servers target group. Thus, to direct installation activities to the targetable entity A 114, installation activities may be directed to the servers target group 106. As will be explained in more detail below, commands may be used to limit deployment of installation activities to systems in a root portion of the hierarchy.

Notably, as used herein, installation activities may include any one of a number of actions. For example, installation activities may include installing software, uninstalling software, installing data, uninstalling data, blocking, and scanning.

Installing software may include for example, installing new applications, and/or updates to existing applications, drivers, and the like. Installing data may include, for example installing data sets for use by applications installed at a targetable entity. Installing data may also include installing and/or changing configuration data. Uninstalling data and software may include removing software applications drivers, configuration data, and the like from a targetable entity.

Blocking includes preventing installation activates from occurring at lower hierarchical levels in a target group. For example, a block installation activity may be directed to the servers target group 106. Thus, when a particular installation activity is directed to the servers target group 106, the particular installation activity will not be applied to the database servers target group 110 because of the block installation activity previously directed to the servers target group 106. In other words, a block prevents an installation activity directed at a parent target group from propagating to children groups. As such, installation activities defined in a parent group are blocked from the entire subtree of groups rooted in the parent group. An identical activity could be directed to groups rooted in the parent group, but they will be independent from the activity directed to the parent group.

Scanning may include querying targetable entities to determine if systems would participate in a given installation activity if the opportunity to participate in a given installation activity presents itself. For example, a scan may determine if a system would install a particular update if the update were rolled out. Updates may be dependent on hardware and/or software already at a targetable entity. Thus, a targetable entity can respond to a scan by indicating that it would participate in the installation activity because of the presence of the appropriate hardware and/or software at the targetable entity. The scan operation, or other installation activities, may include, in some embodiments, sending metadata that describes the installation activity including descriptions of software to be installed if applicable, includes applicability rules for the installation activity (such as software, operating system, and/or hardware requirements), includes installation instructions, version information, a classification (such as information indicating that the installation activities apply to an application, a performance update, a security update and/or a critical update), and/or other appropriate information.

An additional installation activity may include an evaluation operations to gather information at a targetable entity. For example, an evaluation installation activity may run a script or application to test one or more settings or to collect data at a targetable entity and to return test information or collected information. For example, an installation activity may be able to determine if any administrators are logged into any targetable entities in a database servers target group. In another example, an installation activity could collect program status log files on all client systems in an engineering target group. While specific examples have been enumerated here, it should be understood that other information may be collected as well.

Notably, as described above, with the ability of targetable entities to exist in different target groups, a single targetable entity may be targeted for conflicting installation activities. For example, and referring again to FIG. 1, the targetable entity A 114 may be the target of an installation activity that requires the targetable entity A 114 to install a given application as a consequence of being a member of the test target group 104. The targetable entity A 114 may be the target of a conflicting installation activity that requires the targetable entity A 114 to uninstall the same application as a result of its membership in the server's target group 106. Conflict rules may be included in some embodiments to detect and resolve conflicting installation activities targeted at a single targetable entity. Some of the conflict rules include for example a comparison of a position in a hierarchy, a determination of importance of installation activity based on the particular installation activity specified, and a determination of importance based on particular properties of the installation activities. While certain conflict rules have been enumerated here, the enumeration of such rules is not intended to be exhaustive of rules that may be used in embodiments claimed herein.

As described above, one class of conflict rules is based on the hierarchy a level of a target group. In one embodiment, installation activities targeted to narrower or lower hierarchical level target groups are given a higher weight where higher weights dictate a preference for installation activities. For example, and referring again to FIG. 1, installation activities directed at the database server target group 110 have a higher weight than installation activities directed to the servers target group 106. This particular weighting conflict rule illustrates a preference for narrower groups. In one particular embodiment, the hierarchical weighting may be performed across the target groups of the same hierarchical level. For example, based on their position in the hierarchy, the test target group 104 is assigned the same weight as the servers target group 106. Similarly, the database servers target group 110 is assigned the same weight based on position in a hierarchy as the mail servers target group 112. Thus, in one particular example where all other factors are equal, when an installation activity targeted to the database servers target group 110 conflicts with an installation activity targeted to the test target group 104, the conflict will be resolved in favor of the installation activity directed to the database server started group 110 because of the database servers target group's position in the hierarchy.

Notably, the weights assigned based on position in a hierarchy may be combined with weights assigned based on other characteristics or conditions. For example, a test target group 104 may be assigned a weight that is higher than a server target group 106 based on a desire to ensure that appropriate testing of software installation activities, applications, and/or data is appropriately performed within an organization. Thus, the test target group 104 may have a weight assigned to it based on its designation as a test target group and a separate weight assigned to it based on its position in the hierarchy. Similarly, the servers target group 106 may have a weight assigned to it based on its designation as a server target group and a weight assigned to it based on the its position in the hierarchy. The combination of weights assigned to the target groups may result in the test target group 104 having a higher weight, or a preference for installation activities directed to the test target group 104, as compared to the servers target group 106 even though the test target group 104 and the server target group 106 are positioned similarly within a hierarchy.

Weighting may also be assigned to installation activities based on the installation activity specified. As described above, some particular installation activities include install, un-install, block and scan. One particular embodiment includes installation rules that result in higher weights, and thus a preference, for install over un-install, block and scan, and un-install over block and scan. Thus, for example, with all other factors being equal, if a targetable entity is part of a target group to which an install action is specified and part of a different target group for which an un-install action is specified, the install action will be more heavily weighted or preferred.

Weighting rules can also be associated with properties of an installation activity. For example, one installation activity may specify installation of an update with a particular revision number. A conflicting installation activity may specify the same update but with a different revision number. In one embodiment, later revision numbers are more heavily weighted or more preferred over earlier revision numbers.

Some embodiments include functionality for a staged roll-out of installation activities. For example, a roll-out may be intended for a number of target groups. However, it may be desirable to ensure that the installation activities are successful on a given number of targetable entities before performing the installation activities at all of the targetable entities specified in the staged roll-out. One illustrative embodiment includes functionality whereby successfulness of installation activities can be gauged before a complete roll-out is attempted.

For example, in one embodiment, installation activities can be begun at a first target group. Referring now to FIG. 2 an installation server 202 is shown with connections to target groups, including a first target group 204, a second target group 206, and a third target group 208. A staged roll-out in the example shown may be intended for the first target group 204, the second target group, 206 and the third target group 208. Installation activities can be begun at the first target group 204. For example, software installation may be attempted on targetable entities such as targetable entity 210 in the first target group 204.

As shown in FIG. 2, each of the targetable entities 210 in the first target group 204 includes a database 212. The database contains entries that track software installation activities that have taken place at the targetable entity 210. For example, the database 212 may include information indicating that software or data was successfully installed on the targetable entity 210. The database 212 may also include indicators that installation activities were unsuccessful at the targetable entity 210. The database 212 may be readable by an external entity such as a tracking server, or the installation server 202. Thus, in one embodiment, when a staged roll-out is performed, the successfulness of installation activities can be gauged by reference to the databases 212.

Returning once again to the example where a staged roll-out is begun by targeting installation activities at the first target group 204, installation activities may be subsequently targeted at other target groups after some predetermined condition has been met at the first target group. For example, a rule may require that a software application be successfully installed on 95% of the targetable entities 210 at the first target group 204 before installation activities are targeted at the second target group 206 and the third target group 208. Various other rules may also be used. Although the following paragraphs describe some of the rules that may be implemented, the inclusion of such rules is in nowise intended to be exhaustive of the rules contemplated by the embodiments within the scope of what is claimed.

As described above, one rule may require a successful number or percentage of installation activities. In the example where a successful percentage is gauged, the percentage may be based on, for example, the total number of targetable entities 210 in a target group 204. For example, if 95% of all of the targetable entities in the first target group 204 have successfully installed a particular software component, installation activities may be started at the second target group 206 and the third target group 208.

In an alternative embodiment, the percentage may be based on the total number of targetable entities that can, should, and/or need to perform the installation activities. An example of this case occurs for example when certain targetable entities have certain hardware and/or software installed whereas other targetable entities in the target group do not have the certain hardware and/or software installed. For example, the installation activities may include installing an updated driver for a particular model of video card. Targetable entities that do not have both the particular model of video card and the particular driver for the video card will not have need to install the updated driver. As such, a percentage of successful installations may be based on the number of targetable entities that include both the particular video card and the particular driver for the video card.

Other conditions for continued roll-out in a staged roll-out are time based conditions. For example, a rule may specify that a roll-out including installation activities have been performed at a first target group for a specified period of time before installation activities are performed at subsequent target groups. This may be done for example to ensure that installation activities and/or installed software and/or data function appropriately on targetable entities before rolling-out installation activities to a large number of targetable entities. The time based rules may specify that applications have had an opportunity to execute on targetable entities for some period of time. Alternatively, the time based rules may specify that installed data has been available for use at a targetable entity for some period of time. Understandably, embodiments may include evaluating the number or percentage of successful installation activities after some period of time.

An installation server 202, in one example, may provide metadata to a targetable entity 210 separate from the installation activities. The metadata may include, among other things, a description of software to be installed, an ID number, including a package serial number and a revision number, applicability rules, a reference to the software that is described in the installation instructions for installing the software, and a classification of the software, such as a classification as an application or a security or critical update.

The metadata further may include a hash of a signed cabinet file containing the installation activities described by the metadata so as to permit a determination that the cabinet file has not been altered or corrupted.

At the targetable entity 210, the targetable entity 210 examines the metadata to determine if the software to be installed is applicable to the particular the targetable entity 210. For example, software may be applicable to computers running certain operating system including service pack levels of the operating system, running certain software, having certain hardware, running a particular CPU architecture, etc. Additionally, the applicability rules may further specify that the installation activities should not take place if the particular installation activities have previously occurred at the targetable entity. For example, if installation activities have previously If the targetable entity 210 determines from the metadata that installation activities are appropriate for the targetable entity 210, then the targetable entity 210 sends a request to the installation server 202 to obtain the installation activities, which may include software packaged in a cabinet file for installation. The installation server 202 then sends the cabinet file to the targetable entity 210.

At the targetable entity 210, the targetable entity 210 performs a hash calculation on the received cabinet file. This calculated hash can then be compared to a hash included in the metadata to ensure that the cabinet file has not been corrupted or maliciously altered. As described previously, the cabinet file may be signed at the installation server 202. The targetable entity 210 may also validate this signature to ensure the validity of the cabinet file. If the cabinet file passes these validation steps, the targetable entity 210 can follow installation instructions included in the metadata to install the software included in the cabinet file. For example, the installation instructions may specify a particular command line instruction and/or installation tool to install the software included in the cabinet file.

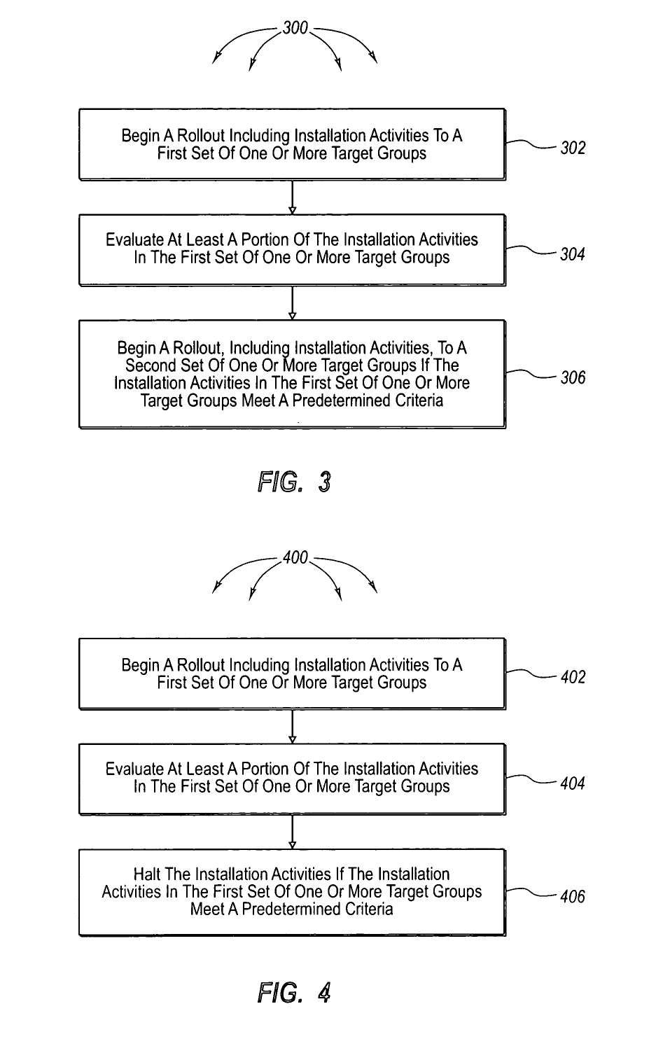

Referring now to FIG. 3, a method 300 is illustrated. The method 300 may be practiced for example in a network computing environment including one or more targetable entities organized into target groups. The method 300 is a method of performing software installation activities. The method 300 includes beginning a rollout including installation activities to a first set of one or more target groups (act 302). For example, and referring to FIG. 1, a rollout may include targeting installation activities to one or more of the target groups 104, 106, 108, 110, and 112. The installation activities may include for example, activities such as installing a software application or update, uninstalling a software application or update, blocking, and/or scanning. Blocking may include, for example, limiting other installation activities within a hierarchy. For example, a block activity directed at the database servers target group 110 prevents certain installation activities from being performed at the database servers target group 110 when the certain installation activities are directed to the servers target group 106.

Referring now again to FIG. 3, FIG. 3 illustrates that method 300 further includes an act of evaluating at least a portion of the installation activities in the first set of one or more target groups (act 304). For example, in one embodiment, evaluating at least a portion of the installation activities (act 304) may include evaluating the percentage of successful installations in the set of first target groups. Evaluating the percentage of successful installations may include evaluating a percentage of successful installations for all targetable entities in a set of one or more target groups. Alternative embodiments may also evaluate a raw number of targetable entities that have successfully installed an update.

In one embodiment where the method 300 may be such that the installation activities include installing updates. In this example evaluating the percentage of successful installations includes evaluating a percentage of successful installations for targetable entities in a set of one or more target groups that have a need for a particular update. Thus, as contrasted with the example above, rather than evaluating installations, or other installation activities, for all targetable entities, installations are evaluated only for targetable entities that have need of a particular update. Targetable entities in a set of target group that have a need for a particular update may have need for the update by virtue of hardware and/or software installed at the targetable entity. For example, if a targetable entity has a particular video card installed for which an update is being published, the targetable entity will have need for the update. As such, the targetable entity can be included in the entities evaluated. In contrast, a targetable entity in a target group to which the update is being published, but which does not include the particular video card will not be included in the evaluated targetable entities for this particular embodiment.

In another Alternative embodiment, evaluating at least of portion of the installation activities in the first set of target group may include determining that a predetermined amount of time has expired since beginning the installation activities in the set of first target group. This particular embodiment can be particularly useful in performing a “burn-in” analysis of a set of targetable entities to ensure that the installation activities do not cause unwanted effects over a reasonable period of time.

If the installation activities in the first set of one or more target groups meet predetermined criteria, such as a successful percentage, successful number, successful period of time, and the like, the method 300 further includes an act of beginning a rollout, including installation activities, to a second set of one or more target groups (act 306).

Illustrating now the functionality of the method of FIG. 3 in one particular embodiment, and referring again to FIG. 1, installation activities can be rolled out to the test target group 104. Once the installation activities have satisfied some predetermined criteria at the test target group 104, such as a successful number of installations on targetable entities, a successful percentage of installation on targetable entities, a predetermined time elapsing, etc, then installation activities can be rolled out to other target groups such as the servers target group 106.

Referring now to FIG. 4 another method 400 is illustrated. The method 400 may be practiced for example, in a network computing environment including one or more targetable entities organized into target groups. The method 400 is a method of performing software installation activities. The method 400 includes beginning a rollout including installation activities to a first set of one or more target groups (act 402). Act 402 is similar to act 302 of FIG. 3. The method 400 further includes evaluating at least a portion of the installation activities in the first target group (act 404). As described in conjunction with FIG. 4, the installation activities may include for example, installations, un-installations, blocks and scans. FIG. 4 further illustrates that if the installation activities in the first set of one or more target groups meet a predetermined criteria, the method 400 further includes halting the installation activities (act 406). In one embodiment the predetermined criteria comprises a threshold of installation failures.

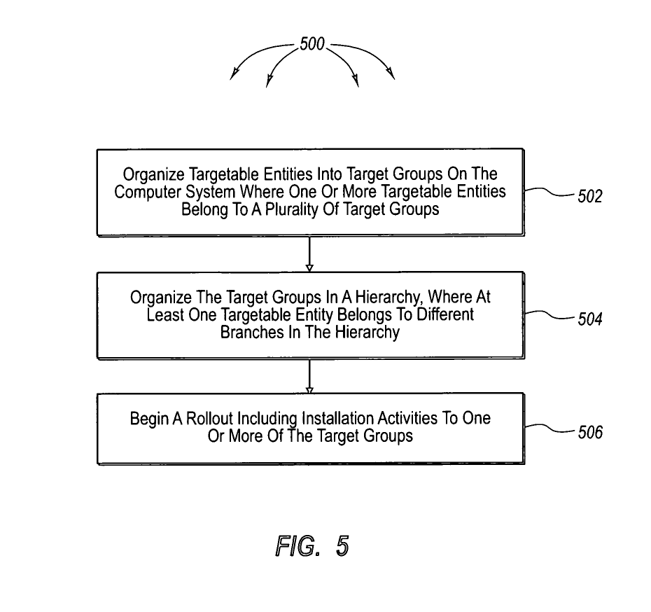

Referring now to FIG. 5, another method 500 is illustrated. The method 500 may be practiced for example, in a computing system, the computing system including a plurality of target groups, where the target groups comprise one or more targetable entities. The method 500 is a method of targeting entities. The method 500 includes organizing targetable entities into target groups in the computing system where one or more targetable entities belong to a plurality of target groups (act 502). For example, as illustrated in FIG. 1, the targetable entity A 114 belongs to the test target group 104, the database servers target group 110 and the servers target group 106.

Referring once again to FIG. 5, the method 500 further includes organizing the target groups in a hierarchy, wherein at least one targetable entity belong to different branches in the hierarchy (act 504). As shown in FIG. 1, the targetable entity A 114 belongs to a target group in the test target group 104 which is in a different branch than the database servers target group 110 to which the targetable entity A also belongs.

Referring once again to FIG. 5, the method 500 further includes beginning a rollout including installation activities to one or more of the target groups (act 506). The installation activities may include for example, deploying software packages and/or software updates. In an alternative embodiment, the installation activities may include deploying one or more data sets. Deploying one or more data sets may include, for example, deploying configuration data. For example, configuration data may be deployed that includes information indicating how software or hardware should be configured.

In an alternative embodiment, beginning a rollout including installation activities may include scanning to determine installation activities that would be performed if available to targetable entities. For example, a scan may be able to determine if a targetable entity would have need of an update if the update were deployed to the targetable entity. One example includes when a targetable entity may have some particular hardware or software for which an update is available. A scan operation can be used to determine if the targetable entity has the software or hardware for which the update is applicable.

Beginning a rollout including installation activities (act 506) may include deploying installation activities according to a set of policy rules. In one exemplary embodiment, the policy rules may include conflict resolution rules for resolving conflicts between conflicting installation activities. For example one installation activity directing an application to be installed may be directed to a targetable entity by virtue of the targetable entity's inclusion in a first target group. A conflicting uninstall installation activity may be specified for the same targetable entity by virtue of its inclusion in a second target group to which the conflicting uninstall installation activity is directed.

Policy rules may be used to determine which installation activity is performed. For example, the policy rules may weight the strength of installation activities by how deep a targetable entity is in a hierarchy. In one embodiment, the deeper in the hierarchy a target group is, the more preferred it is. For example, installation activities directed to database servers target group 110 may be weighted so as to be preferred to installation activities directed to the test target group 104 by virtue of their hierarchical position.

In another embodiment, the policy rules may weight the strength of installation activities by target groups. For example, some target groups may be more preferred than other target groups. As an example, the test target group 104 may be a target group that is preferred over other target groups in that testing of installation activities may be considered to be especially important.

In another embodiment, the policy rules may weight the strength of installation activities by weighting the installation activities themselves. For example, as described above, install activities may be preferred over uninstall activities, scan activities and block activities. Uninstall activities may be preferred over scan and block activities, and so forth.

In another embodiment, the policy rules may weight the strength of installation activities by revision version of an installation activity. For example, a revision version may include information that gives an indication of when an installation activity was published with respect to other installation activities. Thus, in one embodiment, installation activities that are published later will be preferred over earlier published installation activities.

Embodiments may also include functionality for checking to see if installation activities have previously been performed for a particular targetable entity. For example, as described previously, metadata describing particular installation activities can be transmitted to a targetable entity independent of installation activity information. The metadata may include information identifying the particular installation activity as well as applicability rules describing when the installation activities should be performed. As such, the targetable entity can determine that installation activities are inappropriate as a result of the installation activities having already taken place at the targetable entity. In one embodiment, the applicability rules in the metadata may specify that installation activities should occur so long as the installation activities have not already occurred at the targetable entity. This particular embodiment allows reinstallations to be performed by allowing the metadata to specify that installation activities should be performed when installation activities may have been previously performed at the targetable entity. In other embodiments, a targetable entity may be automatically configured not to perform installation activities previously performed.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a network computing environment including one or more targetable entities organized into target groups, a method of performing software installation activities, the method comprising:
beginning a rollout including installation activities to a first set of one or more target groups;
evaluating at least a portion of the installation activities in the first set of one or more target groups; and
if the installation activities in the first set of one or more target groups meet a predetermined criteria, beginning a rollout, including installation activities, to a second set of one or more target groups.

2. The method of claim 1, wherein evaluating at least a portion of the installation activities comprises evaluating the percentage of successful installations in the first set of one or more target groups.

3. The method of claim 2, wherein evaluating the percentage of successful installations comprises evaluating a percentage of successful installations for all targetable entities in the first set of one or more target groups.

4. The method of claim 2, wherein the installation activities comprise installing updates, and wherein evaluating the percentage of successful installations comprises evaluating a percentage of successful installations for targetable entities in the first set of one or more target groups that have a need for a particular update.

5. The method of claim 4, wherein targetable entities in the first set of one or more target groups that have a need for a particular update have need for the update by virtue of hardware and/or software installed at the targetable entity.

6. The method of claim 1, wherein evaluating at least of portion of the installation activities in the first set of one or more target groups comprises determining that a predetermined amount of time has expires since beginning the installation activities in the first set of one or more target groups.

7. The method of claim 1, wherein the installation activities comprise at least one of installing a software application or update, uninstalling a software application or update, blocking, and/or scanning.

8. In a network computing environment including one or more targetable entities organized into target groups, a method of performing software installation activities, the method comprising:
beginning a rollout including installation activities to a first set of one or more target groups;
evaluating at least a portion of the installation activities in the first set of one or more target groups; and
if the installation activities in the first set of one or more target groups meet a predetermined criteria, halting the installation activities.

9. The method of claim 8, wherein the predetermined criteria comprises a threshold of installation failures.

10. In a computer system, the computer system comprising a plurality of target groups, wherein the target groups comprise one or more targetable entities, a method of targeting entities, the method comprising:
organizing targetable entities into target groups on the computer system wherein one or more targetable entities belong to a plurality of target groups;
organizing the target groups in a hierarchy, wherein at least one targetable entity belongs to different branches in the hierarchy; and
beginning a rollout including installation activities to one or more of the target groups.

11. The method of claim 10, wherein the installation activities comprise deploying software packages, software updates and/or one or more data sets.

12. The method of claim 11, wherein deploying one or more data sets comprises deploying configuration data.

13. The method of claim 10, wherein the installation activities comprise performing scan operations to determine targetable entities that would perform an installation activity and/or evaluation operations to gather information at a targetable entity.

14. The method of claim 10, wherein beginning a rollout including installation activities comprises deploying installation activities according to a set of policy rules.

15. The method of claim 14, wherein the policy rules comprise conflict resolution rules for resolving conflicts between conflicting installation activities.

16. The method of claim 15, wherein the policy rules weight the strength of installation activities by how deep a targetable entity is in a hierarchy.

17. The method of claim 15, wherein the policy rules weight the strength of installation activities by target group.

18. The method of claim 15, wherein the policy rules weight the strength of installation activities by weighting the installation activities.

19. The method of claim 15, wherein the policy rules weight the strength of installation activities by revision version of an installation activity.

20. The method of claim 10, wherein beginning a rollout including installation activities comprising scanning to determine installation activities that would be performed if available to targetable entities.
